(19) United States
(12) Patent Application Publication
(10) Pub. No.: US 2024/0394589 A1
(43) Pub. Date: Nov. 28, 2024

(54) System and Method for Automatically Determining Stride Values in Online Streaming Speech Processing Systems

(71) Applicant: Nuance Communications, Inc., Burlington, MA (US)

(72) Inventors: Dario Albesano, Venaria Reale (IT); Felix Weninger, Wellesley, MA (US); Puming Zhan, Acton, MA (US)

(21) Appl. No.: 18/323,557

(22) Filed: May 25, 2023

(51) Int. Cl. G06N 20/00; G10L 15/06

(52) U.S. Cl. CPC G06N 20/00; G10L 15/063

(57) ABSTRACT

A method, computer program product, and computing system for determining a stride value for a first machine learning model. Transfer learning from the first machine learning model to a second machine learning model is performed, wherein the second machine learning model is an online streaming machine learning model. A spectral pooling layer is inserted into the second machine learning model using the stride value. The second machine learning model is trained with the spectral pooling layer.

### BACKGROUND

Speech processing has historically been limited by the computing resources of the speech recording device. With the ability to stream speech signals to more powerful computing devices, limitations in speech processing move from speech recording devices to the machine learning models and neural networks used by the larger, online streaming computing devices. However, configuring certain parameters (e.g., stride value) of online streaming machine learning models has generally been limited to predefined values that cannot be determined automatically. As such, as such, the manually pre-defined values may not be suitable for achieving optimal trade-off between recognition accuracy and real-time factor without introducing signal processing inefficiencies or loss.

### BRIEF DESCRIPTION OF THE DRAWINGS

FIG. 1 is a flow chart of one implementation of the automatic training process;

FIG. 2 is a diagrammatic view of a neural network in accordance with one implementation of the automatic training process;

FIG. 3 is a diagrammatic view of a non-streaming machine learning model being used to determine stride values and train an online streaming machine learning model in accordance with various implementations of the automatic training process;

FIG. 4 is a diagrammatic view of a cropping mask in accordance with one implementation of the automatic training process;

FIGS. 5A-5C are diagrammatic view of spectral pooling in accordance with one implementation of the automatic training process;

FIG. 6 is a diagrammatic view of a speech signal chunked into multiple chunks for processing by an online streaming machine learning model in accordance with one implementation of the automatic training process;

FIG. 7 is a flow chart of one implementation of the automatic training process;

FIG. 8 is a diagrammatic view of multiple cropping masks in accordance with one implementation of the automatic training process;

FIG. 9 is a diagrammatic view of a first online streaming machine learning model being used to determine stride values and train a second online streaming machine learning model in accordance with various implementations of the automatic training process; and

FIG. 10 is a diagrammatic view of a computer system and the automatic training process coupled to a distributed computing network.

Like reference symbols in the various drawings indicate like elements.

### DETAILED DESCRIPTION OF THE PREFERRED EMBODIMENTS

As will be discussed in greater detail below, implementations of the present disclosure allow a stride value to be determined automatically for use with online streaming machine learning models within speech processing systems. For example, a stride value is the reduction factor in an output of a layer of a machine learning model's neural network. For example, the stride value defines the factor by which an input will be reduced during processing by a subsequent layer of a machine learning model's neural network. In one example with automated speech recognition (ASR) models (e.g., Transformer and Conformer Transducers), the computing cost of the attention weights increases quadratically with increase in input sequence length. As such, downsampling an input to a layer within a machine learning model's neural network can reduce computing costs. However, downsampling can also lead to accuracy degradation. Accordingly, downsampling provides an effective trade-off between accuracy (where accuracy is generally measured in terms of word error rate (WER)) and speed (where speed is measured in terms of real-time factor (RTF)). As will be discussed in greater detail below, downsampling may be performed using a stride value.

When using an online streaming machine learning model, the individual sequence or chunk processed may vary over time and/or across online streaming machine learning models. As such, conventional approaches with fixed or predefined stride values are unable to account for varying sequence lengths or variations in machine learning models while balancing accuracy and speed. Accordingly, implementations of the present disclosure allow for the dynamic determination or “learning” of a stride value for an online machine learning model. In some implementations, a non-streaming (offline) machine learning model determines the stride value which is used to train an online streaming machine learning model using transfer learning from the non-streaming machine learning model. In some implementations, a first online streaming machine learning model determines the stride value with a period of future context which is used to train a second online streaming machine learning model using transfer learning from the first online streaming machine learning model.

The details of one or more implementations are set forth in the accompanying drawings and the description below. Other features and advantages will become apparent from the description, the drawings, and the claims.

### The Automatic Training Process

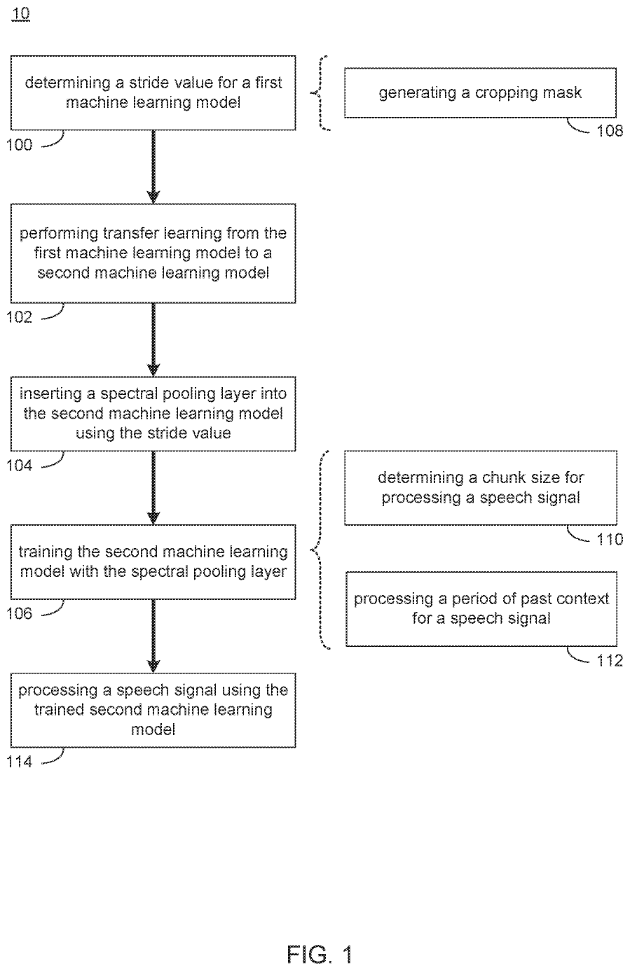

Referring to FIGS. 1-9, automatic training process 10 determines 100 a stride value for a first machine learning model. Transfer learning from the first machine learning model to a second machine learning model is performed 102, wherein the second machine learning model is an online streaming machine learning model. A spectral pooling layer is inserted 104 into the second machine learning model using the stride value. The second machine learning model is trained 106 with the spectral pooling layer.

As discussed above, implementations of the present disclosure allow for a stride value to be determined automatically for use with online streaming machine learning models within speech processing systems. A stride value is the reduction factor in an output of a layer of a machine learning model's neural network. For example, the stride value defines the factor by which an input will be reduced during processing by a subsequent layer of a machine learning model's neural network. In one example with automated speech recognition (ASR) models (e.g., Transformer and Conformer Transducers), the computing cost of the attention weights increases quadratically with increase in input sequence length. As such, downsampling an input to a layer within a machine learning model's neural network can reduce computing costs. However, downsampling can also lead to accuracy degradation. Accordingly, downsampling provides an effective trade-off between accuracy and speed.

As will be discussed in greater detail below, downsampling may be performed using a stride value. As will be discussed in greater detail below, implementations of the present disclosure allow for the dynamic determination or “learning” of a stride value for an online machine learning model by: determining a stride value using a first machine learning model (e.g., a non-streaming machine learning model or an online streaming machine learning model); inserting a spectral pooling layer into a second machine learning model with the stride value determined for the first machine learning model; perform transfer learning from the first machine learning model to the second machine learning model; and training the second machine learning model with the spectral pooling layer.

In some implementations, a speech processing machine learning model includes a neural network for processing speech input to generate a particular output (e.g., text in the example of ASR, a probability score in the example of a biometric verification system, an enhanced speech signal in the example of a speech enhancement system, and/or an obscured speech signal in the example of a speech filtering system). In some implementations, the speech processing system uses an “End-2-End” machine learning model that natively integrates all the needed steps for processing the speech signal.

Typically, recurrent neural network transducer (RNN-T) models are used in ASR speech processing systems. A RNN-T model is composed of three components: the acoustic encoder that receives in input the speech segments to be recognized and generates a corresponding high-level representation; the prediction network that autoregressively incorporates previously emitted symbols into the model; and the joiner, that mixes both acoustic and autoregressive label representations via a monotonic alignment process. In some implementations, neural network 200 is a prediction network that uses the context of past chunks and/or future chunks to process a given chunk of the input speech signal.

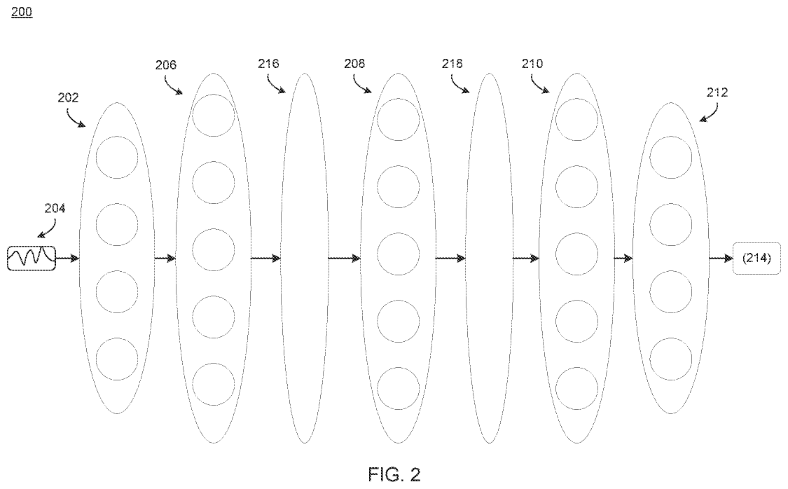

Referring also to FIG. 2, neural networks/artificial neural networks (e.g., neural network 200) include an input layer (e.g., input layer 202) that receives input data. In the example of speech processing, input layer 202 receives a speech signal (e.g., speech signal 204) in the time-domain. Neural network 200 includes a plurality of processing layers (e.g., layers 206, 208, 210) between the input layer (e.g., input layer 202) and an output layer (e.g., output layer 212). In some implementations, each layer (e.g., layers 206, 208, 210) is a mathematical function designed to produce an output specific to an intended result. In the example of an RNN-T model, neural network 200 includes an input layer (e.g., input layer 202), a MHSA layer (e.g., MHSA layer 206), a convolutional layer (e.g., convolutional layer 208), additional processing layer(s) (e.g., layer 210), and an output layer (e.g., output layer 212). MHSA layer 206 is a Multi Head Self Attention layer that allows neural network 200 to account for global context information with particular emphasis on past portions of the speech signal by focusing “attention” on more important portions of the speech signal and lessening “attention” on less important portions of the speech signal. Convolutional layer 208 allows neural network 200 to better model local correlations in the speech signal being processed. As will be discussed in greater detail below, neural network 200 is autoregressive model that uses attention mechanisms to generate enhances predictions for speech processing. Neural network 200 is often referred to as a “Conformer”.

### Offline-Online Training

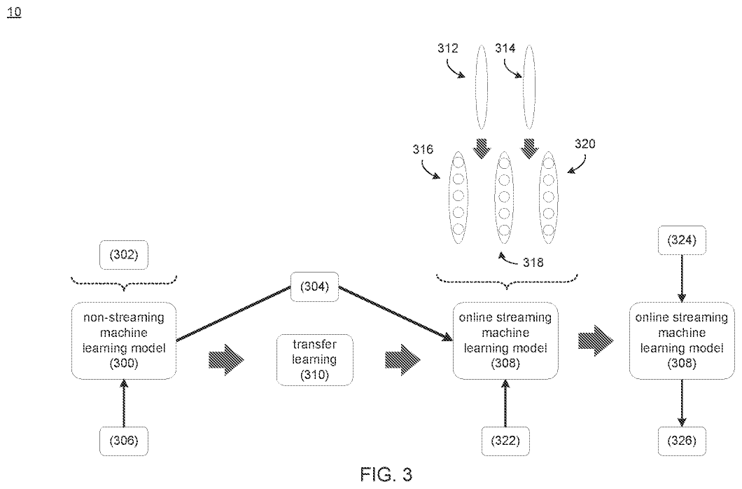

In some implementations, the first machine learning model is a non-streaming machine learning model. Referring also to FIG. 3, a non-streaming machine learning model (e.g., non-streaming machine learning model 300) is a machine learning model that processes non-streaming or offline inputs. For example, suppose non-streaming machine learning model 300 is a machine learning model of a speech processing system. In this example, non-streaming machine learning model 300 is an offline machine learning model if the entirety of a speech signal is available to the machine learning model when processing the speech signal. In other words, the speech signal being processed is not being streamed in chunks or portions for piecemeal processing. In another example and as will be discussed in greater detail below, a machine learning model that processes a speech signal in chunks or portions at a time (e.g., while an individual is speaking to produce the speech signal) is an online streaming machine learning model. As will be discussed in greater detail below and in some implementations, the stride value(s) determined for a non-streaming machine learning model may be dissimilar when compared to the stride value(s) determined for an online streaming machine learning model.

In some implementations, automatic training process 10 determines 100 a stride value for a non-streaming machine learning model. As discussed above, a stride value is the reduction factor in an output of a layer of a machine learning model's neural network. The stride value defines the factor by which an input will be reduced during processing by a subsequent layer of a machine learning model's neural network. In some implementations, the stride value is a non-integer value. For example, the stride value can be applied to any number of downsampling layers (i.e., layer that downsamples the number of input frames to a lesser number of output frames based upon the stride value) within a machine learning model's neural network.

In some implementations, determining 100 the stride value includes generating 108 a cropping mask. For example, to determine 100 the stride value, automatic training process 10 uses a differentiable approximation that multiplies the spectrum of the previous layer activations with a smooth mask function that linearly decreases from “1” to “0”. Accordingly, automatic training process 10 determines 100 stride values for particular spectral pooling layers of a neural network of a machine learning model by generating 108 a cropping mask in the Fourier domain using backpropagation. For example, because the activations of each unit are treated as one-dimensional signals, the cropping mask is generated 108 as shown below in Equation 1:

$$mas {k}_{( s , T , R )} ( n ) = min [ max [ \frac{1}{R} ( R + \frac{T}{2 s} + 1 - n ) , 0 ] , 1 ] \qquad ( 1 )$$

where s is the stride, R is a hyperparameter that controls the smoothing of the mask, and

$$n ∈ [ 0 , \frac{T}{2} + 1 ] .$$

As shown in Equation 1, the cropping mask is applied in the Fourier domain to perform low pass filtering and then to crop the Fourier coefficients where the mask is zero. The cropped Fourier coefficients are transformed back to the time domain by the inverse discrete Fourier transform (DFT). In some implementations, the cropping mask is useful to ensure convergence of the training process because it smooths the cropped signal.

In some implementations, striding affects the computational cost in subsequent layers of the neural network. Accordingly, automatic training process 10 defines a regularization term or value based on each encoder layer stride as shown below in Equation 2:

$$λ J ( {( {S}^{l} )}_{l = 1}^{l = L} ) = λ if l = 1 , else λ {\sum }_{l = 1}^{L} {\prod }_{i = 1}^{l - 1} \frac{1}{{s}^{i}} \qquad ( 2 )$$

where λ is the regularization weight, S^{l} is the total encoder stride up to layer l, sⁱ is the stride introduced by layer i, and L is the total number of layers in the encoder.

By tuning the λ parameter, the regularization term J provides balance between neural network accuracy (i.e., reduction in the number of frames reduces the accuracy by removing data (e.g., speech content in the example of speech processing)) and neural network processing efficiency (i.e., greater stride values result in fewer frames to process with each successive Conformer layer, thus improving the network efficiency). In this manner, the stride is automatically determined allowing a more optimal stride configuration at a lower cost.

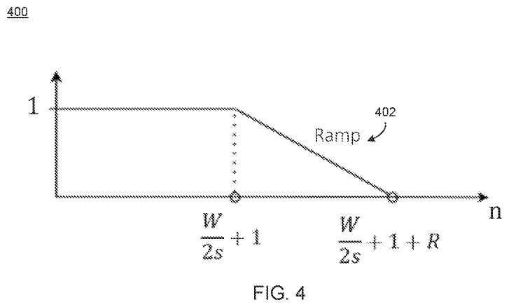

Referring also to FIG. 4, an example of the cropping mask (e.g., cropping mask 400) generated 408 by automatic training process 10 using Equation 1 is shown. In this example, cropping mask 400 includes a smooth mask function that linearly decreases from “1” to “0” or “ramp” (e.g., ramp 402). In some implementations, cropping mask 400 is generated 108 for each portion or chunk of data processed by non-streaming machine learning model 300. Suppose that non-streaming machine learning model 300 is a speech processing system machine learning model. As non-streaming machine learning model 300 processes offline or complete speech signals, cropping mask 400 is generated for an entire utterance with a single ramp (e.g., ramp 402) for the entire utterance. In some implementations, ramp 402 filters Fourier coefficients that ideally would be included in the speech signal. When processing a complete utterance (e.g., during offline training or processing), a single ramp (ramp 402) is found at the end of cropping mask 400, thus resulting in limited signal degradation. However, when performing online streaming of a speech signal, the speech signal is processed in chunks with corresponding cropping masks for each chunk. As such, the ramps of each respective cropping mask weights Fourier coefficients when processing the speech signal that pollutes or degrades the speech signal during subsequent processing. As will be discussed in greater detail below, automatic training process 10 accounts for the ramps of each respective cropping masks by using a stride value determined 100 for the non-streaming machine learning model.

Referring again to FIG. 3, automatic training process 10 provides initial configuration stride value(s) to non-streaming machine learning model to determine 100 the stride value. In one example, initial configuration parameters 302 are provided to non-streaming machine learning model 300 to determine 100 the stride value. For example, initial configuration parameters 302 include, in this example, an initial stride value of 1.0; a smoothing parameter value of 2.0; and regularization weights (0.0, 0.01, 0.025 . . . ). With initial configuration parameters 302, automatic training process 10 performs offline training on non-streaming machine learning model 300 to determine 100 a stride value (e.g., stride value 304). In some implementations, automatic training process 10 determines a respective stride value for multiple downsampling layers in non-streaming machine learning model 300.

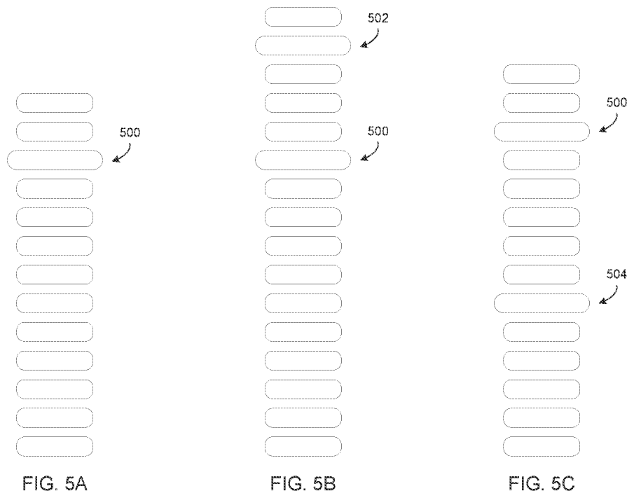

In some implementations, determining 100 the stride value includes inserting downsampling layers into a plurality of Conformer layers of the machine learning model's encoder architecture. For example, suppose an encodes of non-streaming machine learning model 300 includes various Conformer layers as shown in FIG. 5A-5C. For example, in FIG. 5A, automatic training process 10 determines 100 a stride value for a single downsampling layer (e.g., downsampling layer 500) between the tenth and eleventh Conformer layers. In the example of FIG. 5B, automatic training process 10 determines 100 a stride value for a first downsampling layer (e.g., downsampling layer 500) between the tenth and eleventh Conformer layers and a stride value for a second downsampling layer (e.g., downsampling layer 502) between the thirteenth and fourteenth Conformer layers. As shown in FIG. 5C, automatic training process 10 determines 100 a stride value for a first downsampling layer (e.g., downsampling layer 500) between the fifth and sixth Conformer layers and a stride value for a second downsampling layer (e.g., downsampling layer 504) between the tenth and eleventh Conformer layers. In this manner, automatic training process 10 automatically determines 100 a stride value(s) for a downsampling layer. Referring again to FIG. 3 and in one example, suppose that automatic training process 10 determines 100 stride values of 1.94 and 1.45. As will be discussed in greater detail below, automatic training process 10 inserts a spectral pooling layer with the determined stride value.

In some implementations, determining 100 the stride value includes training the non-streaming machine learning model with training data. Training the non-streaming machine learning model includes providing input signals for processing (e.g., speech signals in the example of a speech processing machine learning model) and corresponding labeled output data (e.g., desired output data from the non-streaming machine learning model). As shown in FIG. 3, training data 306 is used to train non-streaming machine learning model 300. In some implementations, each time training data 306 is processed by non-streaming machine learning model 300, non-streaming machine learning model 300 is trained with an “epoch” of training data.

In some implementations, automatic training process 10 performs 102 transfer learning from the non-streaming machine learning model to an online streaming machine learning model. Transfer learning includes taking the relevant parts of a pre-trained machine learning model and applying it to a new but similar problem. In this example, automatic training process 10 performs 102 transfer learning from non-streaming machine learning model 300 to an online streaming machine learning model (e.g., online streaming machine learning model 308) by transferring the trained parameters of non-streaming machine learning model 300 to online streaming machine learning model 308. Examples of trained parameters include the number of Conformer layers, the configuration of Confirmation layers, and other parameters used when processing data. As shown in FIG. 3, performing 102 transfer learning from non-streaming machine learning model 300 to online streaming machine learning model 308 is shown by transfer learning 310. In some implementations, it is possible to train the non-streaming machine learning models using the same number of total epochs as the online streaming machine learning models because the stride values can be determined quickly in a limited number of epochs, and the transfer learning enables the knowledge gained during the pretraining epochs to be used effectively, hence reducing the number of epochs required when training the online streaming machine learning model. This means that automatic training process 10 can achieve the benefits of determined stride values at no increase in training cost.

In some implementations, automatic training process 10 inserts 104 a spectral pooling layer into the online streaming machine learning model using the stride value. Spectral pooling is the dimensional reduction of a time-domain input signal by truncating a frequency-domain representation of the input signal. In some implementations, a speech processing system uses a neural network (within a machine learning model) to process input speech. For example, suppose a speech processing system is an online streaming ASR system that generates a text output for a streamed input speech signal. In this example, the ASR system uses a neural network to perform end-to-end processing of the input speech signal into an output text representation of the speech signal. As will be discussed in greater detail below and in some implementations, the input speech signal is processed by an online streaming neural network (i.e., a neural network that does not need access to the entire speech signal before starting the recognition process). In this example, the speech signal is processed in portions or chunks as opposed to being processed all at once as in an offline (batch-mode) neural network (i.e., where the speech signal is entirely defined before processing with the neural network).

In some implementations, automatic training process 10 filters an output of a Conformer layer of the neural network using the spectral pooling layer with a non-integer stride. For example, filtering the output of the Conformer layer includes reducing the size of the output of the Conformer layer. In some implementations, the output of the Conformer layer is a time-domain signal composed of a number of frames or segments. As discussed above, processing more frames requires more computing resources. As such, automatic training process 10 uses spectral pooling to filter a plurality of frames from the output of the Conformer layer for more efficient processing in subsequent layers of the neural network. In some implementations, automatic training process 10 uses spectral pooling with a stride value to filter the output of the Conformer layer. A stride is the reduction factor in the output of the Conformer layer. Conventional approaches to pooling are limited to integer stride values which result in drastic impacts on computational cost or accuracy. For example, with a stride value of “two” applied on a single layer, the number of frames or samples is reduced by half which greatly reduces the accuracy of the neural network. However and in some implementations, automatic training process 10 uses a non-integer/floating point stride value that is distributable across multiple spectral pooling layers.

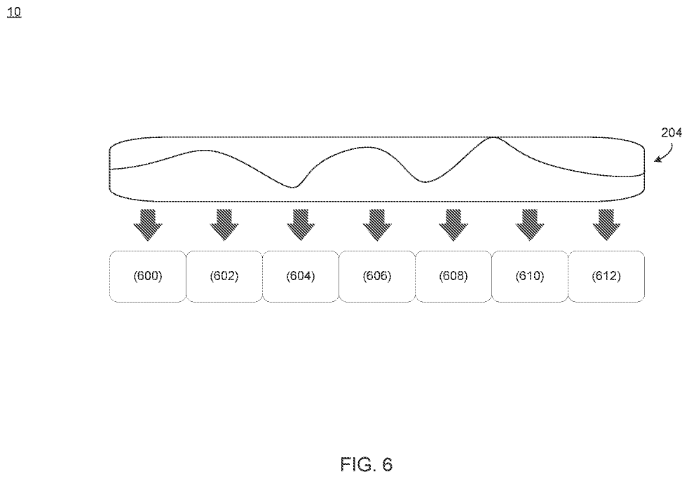

In some implementations, filtering the output of the Conformer layer of the neural network includes converting the output of the Conformer layer from a time-domain signal to a frequency-domain signal. For example, automatic training process 10 converts the output of the Conformer layer from the time-domain signal to the frequency-domain signal. Referring also to FIG. 6, automatic training process 10 performs a discrete Fourier transform (DFT) to convert the time-domain signal output from the Conformer layer (e.g., time-domain signal 600) to the frequency domain. A DFT (e.g., discrete Fourier transform 602) converts a finite sequence of equally spaced samples or frames of the time-domain signal into a same-length sequence of equally spaced samples as a complex-valued function of frequency.

In some implementations, filtering the output of the Conformer layer of the neural network includes filtering a coefficient from the frequency-domain signal using the non-integer stride. For example, with spectral pooling, automatic training process 10 the signal is cut into short segments, each is transformed into a frequency domain signal. The frequency-domain signal (e.g., frequency-domain signal 604) includes various coefficients that correspond to various frequencies of the signal. In some implementations, automatic training process 10 filters a number (e.g., a predefined value or user-defined value) of the Fourier coefficients of high frequencies (e.g., by preserving a predefined number of coefficients, a predefined range of frequencies, or a user-defined range of frequencies). In some implementations, high frequencies often contain noise and less useful information for speech processing environments. Accordingly, automatic training process 10 filters the output of the Conformer layer by filtering one or more coefficients of higher frequencies from the frequency-domain signal while preserving the lower frequency coefficients which are more important than higher frequency coefficients during speech processing. Referring again to FIG. 6 and in some implementations, automatic training process 10 filters frequency-domain signal 604 using a filter (e.g., filter 606) as discussed above to generate a filtered frequency-domain signal (e.g., filtered frequency-domain signal 608).

In some implementations, filtering the output of the Conformer layer of the neural network using the spectral pooling layer includes distributing a stride value across a plurality of spectral pooling layers. For example, different stride values may be used for separate spectral pooling layers. In some implementations, introducing spectral pooling layers to lower or earlier layers of the neural network improves processing speed but tends to degrade the accuracy. As such, automatic training process 10 uses the flexibility of a non-integer/floating point stride to distribute a stride over multiple spectral pooling layers. For example, suppose a neural network includes twenty layers.

In some implementations, filtering the output of the Conformer layer of the neural network using the spectral pooling layer includes performing spectral upsampling on the filtered frequency-domain signal. Spectral upsampling includes inserting zero-valued samples between original samples to increase the sampling rate. For example, recent advances in conformer architecture provide a U-Net like architecture with upsampling and downsampling which can extend to a stride value of sixteen (e.g., 160 milliseconds frame rate). In some implementations, automatic training process 10 performs spectral upsampling as an inverse operation of spectral pooling with non-integer stride. Performing spectral upsampling includes defining or receiving an upsampling factor and appending zeroes in the Fourier domain. Automatic training process 10 then transforms this appended frequency-domain signal to a time-domain signal. In one example, the resulting length of the time-domain signal is [T·u] where T is the time-domain signal and u is the upsample factor.

In some implementations, automatic training process 10 inserts 104 a spectral pooling layer (e.g., spectral pooling layers 216, 218) between Conformer layers of the neural network. In some implementations, inserting 104 the spectral pooling layer into the neural network includes inserting the spectral pooling layer directly between a Conformer layer and a subsequent Conformer layer. For example, automatic training process 10 provides the output of a Conformer layer (e.g., Conformer layer 206) to a spectral pooling layer (e.g., spectral pooling layer 216) and the output of spectral pooling layer 216 to a subsequent Conformer layer (e.g., Conformer layer 218). In some implementations, multiple spectral pooling layers are inserted directly between pairs of Conformer layers of the neural network. For example, spectral pooling layer 216 is inserted directly between Conformer layers 206, 208 and spectral pooling layer 218 is inserted directly between Conformer layers 208, 210. In this manner, spectral pooling layers are inserted directly between any or all of the Conformer layers of the neural network.

In some implementations, automatic training process 10 filters an output of a Conformer layer of the neural network using the spectral pooling layer with a non-integer stride. For example, filtering the output of the Conformer layer includes reducing the size of the output of the Conformer layer. In some implementations, the output of the Conformer layer is a time-domain signal composed of a number of frames or segments. As discussed above, processing more frames requires more computing resources. As such, automatic training process 10 uses spectral pooling to filter a plurality of frames from the output of the Conformer layer for more efficient processing in subsequent layers of the neural network. In some implementations, automatic training process 10 uses spectral pooling with a non-integer stride to filter the output of the Conformer layer. For example, with a stride of “two” applied on a single layer, the number of frames or samples is reduced by half which greatly reduces the accuracy of the neural network. However, automatic training process 10 uses a non-integer/floating point stride parameter that is distributable across multiple spectral pooling layers.

As discussed above and in one example, automatic training process 10 determines 100 non-integer stride values of 1.94 and 1.45. Referring again to FIG. 3, automatic training process 10 inserts 104 a spectral pooling layer (e.g., spectral pooling layers 312, 314) into a plurality of Conformer layers (e.g., Conformer layers 316, 318, 320) of online streaming machine learning model 308.

In some implementations, automatic training process 10 train 106 the online streaming machine learning model with the spectral pooling layer. Training 106 the online streaming machine learning model with the spectral pooling layer includes providing training data in the form of input signals for processing (e.g., speech signals in the example of a speech processing online streaming machine learning model) and corresponding labeled output data (e.g., desired output data from the online streaming machine learning model). As shown in FIG. 3, training data 322 is used to train online streaming machine learning model 308. In some implementations, each time training data 322 is processed by online streaming machine learning model 308, online streaming machine learning model 308 is trained with an “epoch” of training data. As discussed above, by performing 102 transfer learning from non-streaming machine learning model to online streaming machine learning model 308, automatic training process 10 improves the training efficiency of online streaming machine learning model 308 by reducing the amount of training required for online streaming machine learning model 308.

In some implementations, training 106 the online streaming machine learning model with the spectral pooling layer includes determining 110 a chunk size for processing a speech signal. In some implementations, when processing a speech signal (e.g., speech signal 204) using neural network 200, automatic training process 10 divides speech signal 204 into a plurality of chunks or portions of predefined length or size. For example, speech signal 204 is a time-domain signal composed of a number of time frames or portions with speech content. Each frame represents a duration in the time-domain signal (e.g., ten milliseconds). In the example of a time-domain signal for speech signal 204, automatic training process 10 divides speech signal 204 into a plurality of chunks corresponding to a number of frames of speech signal 204. Referring also to FIG. 6 and in one example, automatic training process 10 divides speech signal 204 into chunks representing each frame (e.g., chunks 600, 602, 604, 606, 608, 610, 612). In another example, automatic training process 10 divides speech signal 204 into chunks representing multiple frames. The granularity for dividing speech signal 204 into chunks is a configurable value. In one example, the chunking granularity (e.g., one chunk per frame of speech signal 204) is a user-defined value using a user interface. In another example, the chunking granularity is a default value that is automatically adjusted by automatic training process 10.

In some implementations, training 106 the online streaming machine learning model with the spectral pooling layer includes processing 112 a period of past context for a speech signal. A period of past context is an amount of time (e.g., in terms of time, frames, or chunks) that precedes (e.g., comes before in time) a particular chunk. For example and referring again to FIG. 6, suppose chunk 606 is a chunk being processed at a given time. In this example, processes chunk 606 and a period of past context (e.g., chunks 602, 604). In this example, the period of past context includes two past chunks. As past chunks 602, 604 provide context for processing chunk 606, dynamic neural network process 10 processes this period of past context to enhance the processing of a given or current chunk. In another example, the period of past context from speech signal 204 defined as an amount of time prior to chunk 606 (e.g., a number of milliseconds, seconds, etc.). In one example, the period of past context is user-defined. In another example, the period of past context is determined by automatic training process 10 during training 106 of online streaming machine learning model 308. For example, automatic training process 10 adjusts or tunes the duration of the period of past context to determine which duration provides a desired balance between processing speed and accuracy.

In some implementations, automatic training process 10 processes 114 a speech signal using the trained online streaming machine learning model. For example, suppose a speech processing system is being used to process speech signals (e.g., speech signal 324 as shown in FIG. 3) at run-time. With each speech signal, automatic training process 10 uses the trained online streaming machine learning model (e.g., online streaming machine learning model 308) to process speech signals (e.g., speech signal 324). In the example of ASR, online streaming machine learning model 308 generates a text-based output (e.g., output 326).

Implementations of the present disclosure allow an online streaming machine learning model to be trained with a automatically determined stride value by using a non-streaming machine learning model to determine the stride value and transfer learning to reduce training time and resources. In this manner, signal degradation is reduced that would otherwise be experienced when determining the stride values for the online streaming machine learning model directly by using the cropping mask for the entire utterance (e.g., non-streaming). As shown in Table 1 below, implementations of the present disclosure reduce the real time factor (RTF) in a trained online streaming machine learning model by 21% using a first set of automatically determined stride values (e.g., a stride value of “2.00” in a spectral pooling layer inserted between the tenth and eleventh Conformer layers and a stride value of “1.40” in a spectral pooling layer inserted between the twelfth and thirteenth Conformer layers) with only a 0.3% decrease in accuracy. Similarly, a 30.3% reduction in RTF with only a 1.5% decrease in accuracy is observed using a second set of automatically determined stride values (e.g., a stride value of “1.65” in a spectral pooling layer inserted between the fifth and sixth Conformer layers and a stride value of “1.41” in a spectral pooling layer inserted between the tenth and eleventh Conformer layers).

TABLE 1

| Training | #Epochs | | Insertion | Stride | Insertion | Stride | Total | | |
|---|---|---|---|---|---|---|---|---|---|
| Approach | offline/online | Stride mode | layer #1 | value #1 | layer #2 | value #1 | stride | WER | RTF |
| Baseline 1 | —/90 | Manual | 10 | 2 | — | — | 8 | 13.06 | 1.414 |
| Baseline 2 | —/90 | Manual (Spec. Pool) | 10 | 1.5 | 13 | 1.33 | 8 | 13.00 | 1.291 |
| Independent | 90/90 | λ = 0.025 | 10 | 1.65 | 13 | 2.23 | 12 | 13.08 | 1.188 |
| Integrated | 20/70 | λ = 0.0 | 10 | 2.00 | 13 | 1.40 | 12 | 13.10 | 1.117 |
| Integrated | 20/70 | λ = 0.025 | 10 | 2.69 | 13 | 1.18 | 16 | 13.35 | 1.035 |
| Independent | 90/90 | λ = 0.025 | 5 | 2.50 | 10 | 1.24 | 12 | 13.38 | 0.911 |
| Integrated | 20/70 | λ = 0.0 | 5 | 1.65 | 10 | 1.41 | 10.6 | 13.26 | 0.986 |
| Integrated | 20/70 | λ = 0.025 | 5 | 2.46 | 10 | 1.18 | 13.7 | 13.65 | 0.859 |

where “Baseline 1” represents the best result with an integer stride value; “Baseline 2” represents the best results with spectral pooling; “Independent” represents an offline training to determine stride values and online training where each phase has 90 epochs; “Integrated” represents automatic switching from offline to online and halving training time with transfer learning; “WER” represents “word error rate”; and “RTF” represents real-time factor.

### Online-Online Training

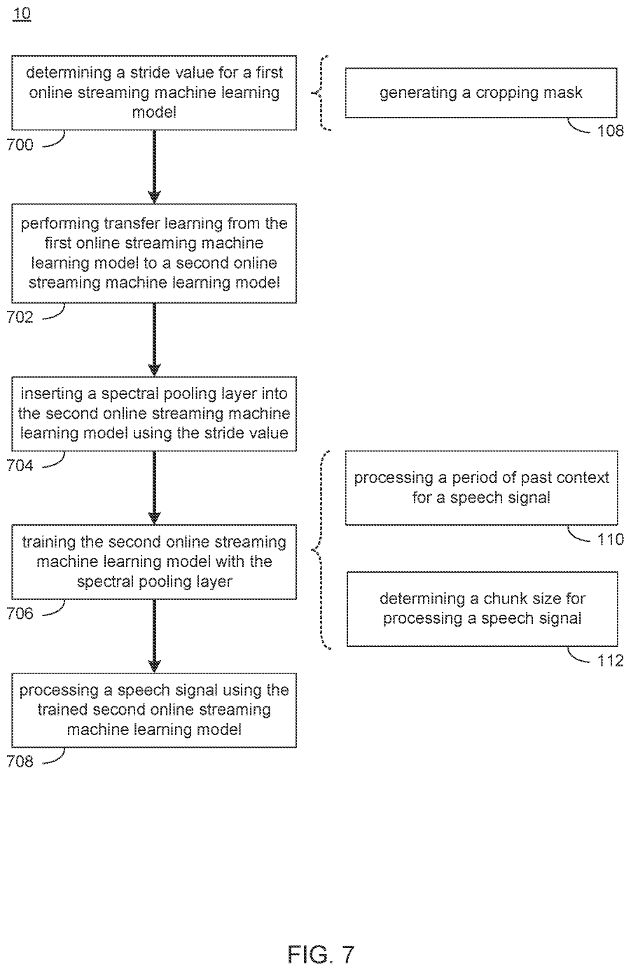

In some implementations, the first machine learning model is a first online streaming machine learning model. For example, using a non-streaming machine learning model may allow for the dynamic determination of stride values without incurring significant accuracy degradation. However, in some implementations, mismatch between the performance of the non-streaming machine learning model and the online streaming machine learning model using the determined stride values can introduce accuracy degradation in the trained online streaming machine learning model. Referring also to FIGS. 7-9, automatic training process 10 determines 700 a stride value for a first online streaming machine learning model and performs 702 transfer learning from the first online streaming machine learning model to a second online streaming machine learning model. A spectral pooling layer is inserted 704 into the second online streaming machine learning model using the stride value, and the second online streaming machine learning model is trained 706 with the spectral pooling layer.

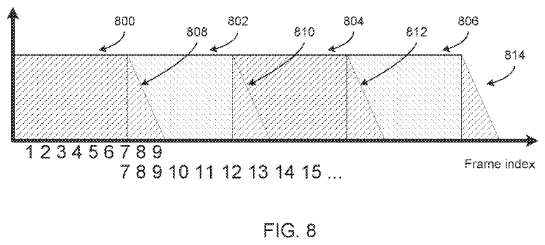

In some implementations, automatic training process 10 determines 700 a stride value for a first online streaming machine learning model. As discussed above, an online streaming machine learning model is a machine learning model that processes input signals (e.g., speech signals in the context of a speech processing system or images in the context of an image processing system) in chunks or portions as the respective chunks are received by the machine learning model. For example and referring again to FIG. 8, suppose a user is speaking into a microphone and desires to process their speech using a speech processing system. In this example, automatic training process 10 receives the input speech signal in chunks (e.g., chunks 800, 802, 804, 806, 808, 810, 812). Accordingly and unlike the case of non-streaming machine learning models, with online streaming machine learning models, the entire utterance is not available during processing. Rather, the input speech signal is processed in chunks.

In some implementations, determining 700 the stride value includes generating 108 a cropping mask. As discussed above and as shown in FIG. 4, when determining a stride value, automatic training process 10 generates 108 a cropping mask, where each mask includes the ramp feature that introduces degradation into the speech signal during processing. In the example of offline or non-streaming machine learning model, the entire utterance is processed, thus resulting in a single ramp with minimal impact on speech processing. However, in the case of online streaming machine learning models, each chunk is processed separately. As such, automatic training process 10 generates 108 a cropping mask for each chunk.

In some implementations, determining a stride value for a first online machine learning model includes processing a period of future context from a speech signal using the first online machine learning model. A period of future context is an amount of time (e.g., in terms of time, frames, or chunks) that follows (e.g., comes after in time) a particular chunk. For example and referring again to FIG. 6, suppose chunk 606 is a chunk being processed at a given time. In this example, automatic training process 10 defines a period of future context (e.g., chunk 608). In this example, the period of future context represented by one chunk. In some implementations, the period of future context is limited by the configuration of the neural network. For example, suppose speech signal 204 is being processed at run-time in an online streaming machine learning model where speech signal 204 is received and processed in real time. In this example, automatic training process 10 does not have access to future context (e.g., chunks 608, 610, 612) at the time of the processing of chunk 606. In another example, the period of future context from speech signal 204 is defined as an amount of time following chunk 606 (e.g., a number of milliseconds, seconds, etc.).

Referring again to FIG. 6 and also to FIG. 8, suppose automatic training process 10 processes four chunks (e.g., chunks 600, 602, 604, 606). In this example, automatic training process 10 generates four cropping masks (e.g., cropping masks 800, 802, 804, 806) each with a respective ramp (e.g., ramps 808, 810, 812, 814).

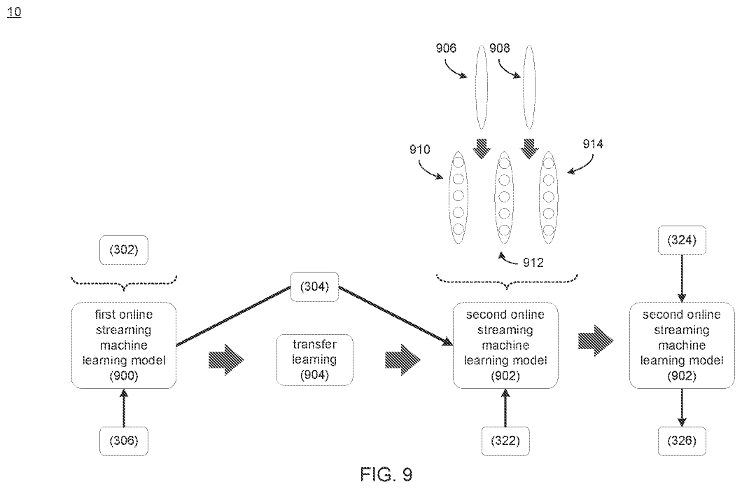

Referring also to FIG. 9 and in some implementations, automatic training process 10 trains a first online streaming machine learning model (e.g., first online streaming machine learning model 900) in the manner discussed above (e.g., using initial configuration parameters 302 and training data 306) with overlapping chunks with a period of future context. In this example, automatic training process 10 defines the period of future context to include the ramp of respective chunk. For example, suppose automatic training process 10 processes chunk 600 by generating cropping mask 800 with ramp 808. In this example, ramp 808 is defined the period of future context such that the next chunk's cropping mask (e.g., cropping mask 802) begins where ramp 808 begins (e.g., shown with overlapping frame numbers “7”-“9”). In this manner, first online streaming machine learning model 900 “sees” (i.e., “processes”) the unmasked version of the entire input signal without degradation. This reduces the pollution of the true chunk frames by the ramp weighting and makes the training of the first online streaming machine learning model converge. As shown in FIG. 9, automatic training process 10 determines 700 a stride value (e.g., stride value 304) and provides stride value 304 to a second online streaming machine learning model (e.g., second online machine learning model 902).

In some implementations, automatic training process 10 performs 702 transfer learning from the first online streaming machine learning model to a second online streaming machine learning model. As discussed above, automatic training process 10 performs 702 transfer learning from first online streaming machine learning model 900 to a second online streaming machine learning model (e.g., second online streaming machine learning model 902) by transferring the trained parameters of first online streaming machine learning model 900 to second online streaming machine learning model 902. Examples of trained parameters include the number of Conformer layers, the configuration of Confirmation layers, and other parameters used when processing data. As shown in FIG. 9, performing 702 transfer learning from first online streaming machine learning model 900 to second online streaming machine learning model 902 is shown by transfer learning 904. As discussed above, by performing 702 transfer learning from an online streaming machine learning model as opposed to a non-streaming machine learning model, automatic training process 10 provides a better matching between the training of the first online streaming machine learning model and the expected outputs of the second online streaming machine learning model.

In some implementations, automatic training process 10 inserts 704 a spectral pooling layer into the second online streaming machine learning model using the stride value. As discussed above, automatic training process 10 inserts 704 a spectral pooling layer (e.g., spectral pooling layers 906, 908) between Conformer layers of a neural network. In some implementations, inserting 704 the spectral pooling layer into the neural network includes inserting the spectral pooling layer directly between a Conformer layer and a subsequent Conformer layer. For example, automatic training process 10 provides the output of a Conformer layer (e.g., Conformer layer 910) to a spectral pooling layer (e.g., spectral pooling layer 906) and the output of spectral pooling layer 906 to a subsequent Conformer layer (e.g., Conformer layer 912). In some implementations, multiple spectral pooling layers are inserted directly between pairs of Conformer layers of the neural network. For example, spectral pooling layer 906 is inserted directly between Conformer layers 910, 912 and spectral pooling layer 908 is inserted directly between Conformer layers 912, 914 of second online streaming machine learning model 902.

In some implementations, automatic training process 10 trains 706 the second online streaming machine learning model with the spectral pooling layer. As discussed above, training 706 the second online streaming machine learning model with the spectral pooling layer includes providing training data in the form of input signals for processing (e.g., speech signals in the example of a speech processing online streaming machine learning model) and corresponding labeled output data (e.g., desired output data from the online streaming machine learning model). As shown in FIG. 9, training data 322 is used to train second online streaming machine learning model 902. In some implementations, training 706 the second online streaming machine learning model with the spectral pooling layer includes determining 110 a chunk size for processing a speech signal and/or determining 112 a period of past context for a speech signal.

In some implementations, automatic training process 10 processes 708 a speech signal using the trained second online streaming machine learning model. For example, suppose a speech processing system is being used to process speech signals (e.g., speech signal 324 as shown in FIG. 11) at run-time. With each speech signal, automatic training process 10 uses the trained second online streaming machine learning model (e.g., second online streaming machine learning model 902) to process speech signals (e.g., speech signal 324). In the example of ASR, second online streaming machine learning model 902 generates a text-based output (e.g., output 326).

Implementations of the present disclosure allow a second online streaming machine learning model to be trained with a automatically determined stride value by using a first streaming machine learning model to automatically determine the stride value and provide a more consistent matching of parameters and accuracy than a non-streaming machine learning model. In this manner, signal degradation is reduced that would otherwise be experienced when determining the stride values for the online streaming machine learning model directly by using the period of future context to account for ramps in each chunk's cropping mask. As shown in Table 2 below, implementations of the present disclosure reduce the real time factor (RTF) in a trained online streaming machine learning model by 26.2% using a first set of automatically determined stride values (e.g., a stride value of “1.85” in a spectral pooling layer inserted between the tenth and eleventh Conformer layers and a stride value of “2.23” in a spectral pooling layer inserted between the twelfth and thirteenth Conformer layers) with less than a 0.2% decrease in accuracy. Similarly, a 40.8% reduction in RTF with only a 2% decrease in accuracy is observed using a second set of automatically determined stride values (e.g., a stride value of “2.11” in a spectral pooling layer inserted between the fifth and sixth Conformer layers and a stride value of “1.63” in a spectral pooling layer inserted between the tenth and eleventh Conformer layers).

TABLE 2

| Training | #Epochs | | Insertion | Stride | Insertion | Stride | Total | | |
|---|---|---|---|---|---|---|---|---|---|
| Approach | offline/online | Stride mode | layer #1 | value #1 | layer #2 | value #1 | stride | WER | RTF |
| Baseline 1 | —/90 | Manual | 10 | 2 | — | — | 8 | 13.06 | 1.414 |
| Baseline 2 | —/90 | Manual (Spec. Pool) | 10 | 1.5 | 13 | 1.33 | 8 | 13.00 | 1.291 |
| Independent | 40/50 | λ = 0.025 | 10 | 1.85 | 13 | 2.23 | 16 | 13.08 | 1.044 |
| Integrated | 40/50 | λ = 0.0 | 5 | 2.21 | 10 | 1.46 | 12 | 13.19 | 0.945 |
| Integrated | 40/50 | λ = 0.025 | 5 | 2.21 | 10 | 1.63 | 13.7 | 13.33 | 0.837 |

### System Overview

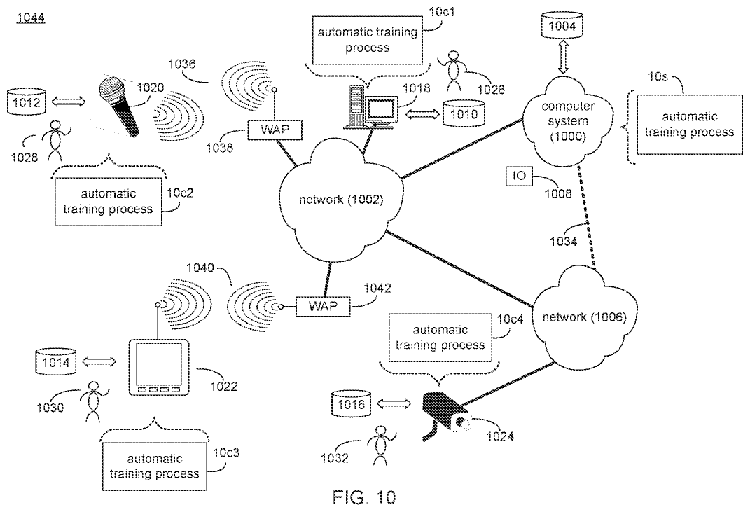

Referring to FIG. 10, there is shown automatic training process 10. Automatic training process 10 may be implemented as a server-side process, a client-side process, or a hybrid server-side/client-side process. For example, automatic training process 10 may be implemented as a purely server-side process via automatic training process 10s. Alternatively, automatic training process 10 may be implemented as a purely client-side process via one or more of automatic training process 10c1, automatic training process 10c2, automatic training process 10c3, and automatic training process 10c4. Alternatively still, automatic training process 10 may be implemented as a hybrid server-side/client-side process via automatic training process 10s in combination with one or more of automatic training process 10c1, automatic training process 10c2, automatic training process 10c3, and automatic training process 10c4.

Accordingly, automatic training process 10 as used in this disclosure may include any combination of automatic training process 10s, automatic training process 10c1, automatic training process 10c2, automatic training process 10c3, and automatic training process 10c4.

Automatic training process 10s may be a server application and may reside on and may be executed by a computer system 1000, which may be connected to network 1002 (e.g., the Internet or a local area network). Computer system 1000 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a minicomputer, a mainframe computer, a RAID device and a NAS system. The various components of computer system 1000 may execute one or more operating systems.

The instruction sets and subroutines of automatic training process 10s, which may be stored on storage device 1004 coupled to computer system 1000, may be executed by one or more processors (not shown) and one or more memory architectures (not shown) included within computer system 1000. Examples of storage device 1004 may include but are not limited to: a hard disk drive; a RAID device; a random-access memory (RAM); a read-only memory (ROM); and all forms of flash memory storage devices.

Network 1002 may be connected to one or more secondary networks (e.g., network 1004), examples of which may include but are not limited to: a local area network; a wide area network; or an intranet, for example.

Various IO requests (e.g., IO request 1008) may be sent from automatic training process 10s, automatic training process 10c1, automatic training process 10c2, automatic training process 10c3 and/or automatic training process 10c4 to computer system 1000. Examples of IO request 1008 may include but are not limited to data write requests (i.e., a request that content be written to computer system 1000) and data read requests (i.e., a request that content be read from computer system 1000).

The instruction sets and subroutines of automatic training process 10c1, automatic training process 10c2, automatic training process 10c3 and/or automatic training process 10c4, which may be stored on storage devices 1010, 1012, 1014, 1016 (respectively) coupled to client electronic devices 1018, 1020, 1022, 1024 (respectively), may be executed by one or more processors (not shown) and one or more memory architectures (not shown) incorporated into client electronic devices 1018, 1020, 1022, 1024 (respectively). Storage devices 1010, 1012, 1014, 1016 may include but are not limited to: hard disk drives; optical drives; RAID devices; random access memories (RAM); read-only memories (ROM), and all forms of flash memory storage devices. Examples of client electronic devices 1018, 1020, 1022, 1024 may include, but are not limited to, personal computing device 1018 (e.g., a smart phone, a personal digital assistant, a laptop computer, a notebook computer, and a desktop computer), audio input device 1020 (e.g., a handheld microphone, a lapel microphone, an embedded microphone (such as those embedded within eyeglasses, smart phones, tablet computers and/or watches) and an audio recording device), display device 1022 (e.g., a tablet computer, a computer monitor, and a smart television), machine vision input device 1024 (e.g., an RGB imaging system, an infrared imaging system, an ultraviolet imaging system, a laser imaging system, a SONAR imaging system, a RADAR imaging system, and a thermal imaging system), a hybrid device (e.g., a single device that includes the functionality of one or more of the above-references devices; not shown), an audio rendering device (e.g., a speaker system, a headphone system, or an earbud system; not shown), various medical devices (e.g., medical imaging equipment, heart monitoring machines, body weight scales, body temperature thermometers, and blood pressure machines; not shown), and a dedicated network device (not shown).

Users 1026, 1028, 1030, 1032 may access computer system 1000 directly through network 1002 or through secondary network 1006. Further, computer system 1000 may be connected to network 1002 through secondary network 1006, as illustrated with link line 1034.

The various client electronic devices (e.g., client electronic devices 1018, 1020, 1022, 1024) may be directly or indirectly coupled to network 1002 (or network 1006). For example, personal computing device 1018 is shown directly coupled to network 1002 via a hardwired network connection. Further, machine vision input device 1024 is shown directly coupled to network 1006 via a hardwired network connection. Audio input device 1022 is shown wirelessly coupled to network 1002 via wireless communication channel 1036 established between audio input device 1020 and wireless access point (i.e., WAP) 1038, which is shown directly coupled to network 1002. WAP 1038 may be, for example, an IEEE 802.11a, 802.11b, 802.11g, 802.11n, Wi-Fi, and/or Bluetooth™ device that is capable of establishing wireless communication channel 1036 between audio input device 1020 and WAP 1038. Display device 1022 is shown wirelessly coupled to network 1002 via wireless communication channel 1040 established between display device 1022 and WAP 1042, which is shown directly coupled to network 1002.

The various client electronic devices (e.g., client electronic devices 1018, 1020, 1022, 1024) may each execute an operating system, wherein the combination of the various client electronic devices (e.g., client electronic devices 1018, 1020, 1022, 1024) and computer system 1000 may form modular system 1044.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
determining a stride value for a first machine learning model;
performing transfer learning from the first machine learning model to a second machine learning model, wherein the second streaming machine learning model is an online streaming machine learning model;
inserting a spectral pooling layer into the second machine learning model using the stride value; and
training the second machine learning model with the spectral pooling layer.

2. The computer-implemented method of claim 1, wherein the first machine learning model is a non-streaming machine learning model.

3. The computer-implemented method of claim 1, wherein the first machine learning model is a first online streaming machine learning model.

4. The computer-implemented method of claim 1, wherein the second machine learning model is an automated speech recognition (ASR) online streaming machine learning model.

5. The computer-implemented method of claim 1, wherein determining the stride value includes generating a cropping mask.

6. The computer-implemented method of claim 1, wherein training the second machine learning model with the spectral pooling layer includes processing a period of past context for a speech signal.

7. The computer-implemented method of claim 1, wherein training the second machine learning model with the spectral pooling layer includes determining a chunk size for processing a speech signal.

8. The computer-implemented method of claim 1, further comprising:
processing a speech signal using the trained second machine learning model.

9. A computing system comprising:
a memory; and
a processor to determine a stride value for a first online streaming machine learning model, to perform transfer learning from the first online streaming machine learning model to a second online streaming machine learning model, to insert a spectral pooling layer into the second online streaming machine learning model using the stride value, and to train the second online streaming machine learning model with the spectral pooling layer.

10. The computing system of claim 9, wherein determining the stride value includes generating a cropping mask.

11. The computing system of claim 9, wherein determining the stride value includes processing a period of future context from a speech signal.

12. The computing system of claim 9, wherein training the second online streaming machine learning model with the spectral pooling layer includes processing a period of past context for a speech signal.

13. The computing system of claim 9, wherein training the second online streaming machine learning model with the spectral pooling layer includes determining a chunk size for processing a speech signal.

14. The computing system of claim 9, further comprising:
processing a speech signal using the trained second online streaming machine learning model.

15. A computer program product residing on a non-transitory computer readable medium having a plurality of instructions stored thereon which, when executed by a processor, cause the processor to perform operations comprising:
determining a stride value for a non-streaming machine learning model;
performing transfer learning from the non-streaming machine learning model to an online machine learning model;
inserting a spectral pooling layer into the online machine learning model using the stride value; and
training the online machine learning model with the spectral pooling layer.

16. The computer program product of claim 15, wherein determining the stride value includes generating a cropping mask.

17. The computer program product of claim 15, wherein training the online streaming machine learning model with the spectral pooling layer includes processing a period of past context for a speech signal.

18. The computer program product of claim 15, wherein training the online streaming machine learning model with the spectral pooling layer includes determining a chunk size for processing a speech signal.

19. The computer program product of claim 15, wherein the online streaming machine learning model is an automated speech recognition (ASR) online streaming machine learning model.

20. The computer program product of claim 15, further comprising:
processing a speech signal using the trained online streaming machine learning model.
